(19) United States
(12) Patent Application Publication
(10) Pub. No.: US 2024/0429527 A1
(43) Pub. Date: Dec. 26, 2024

(54) STRUCTURAL BATTERY ENCLOSURE FOR ELECTRIC WATERCRAFT

(71) Applicant: TAIGA MOTORS INC., Lasalle (CA)

(72) Inventors: Patrick BERNIER, Montreal (CA); Marc-Olivier GAGNON, Montreal (CA); Dante FILICE, Montreal (CA)

(73) Assignee: TAIGA MOTORS INC., Lasalle (CA)

(21) Appl. No.: 18/213,415

(22) Filed: Jun. 23, 2023

(51) Int. Cl. H01M 50/249; B60K 1/04; B60L 50/60

(52) U.S. Cl. CPC H01M 50/249; B60K 1/04; B60L 50/66; B60K 2001/0438; B60L 2200/32; H01M 2220/20

(57) ABSTRACT

Structural battery enclosures for electric watercraft are provided. An electric watercraft comprises a hull having a port side and a starboard side on opposite sides of a longitudinal central axis of the hull, an electric motor for propelling the electric watercraft, a battery operatively connected to drive the electric motor and a frame supporting the battery. The battery is disposed in the interior volume of the hull. The frame includes a port member attached to the port side of the hull and a starboard member attached to the starboard side of the hull. The frame includes a brace extending across the central axis of the hull and interconnecting the port member of the frame with the starboard member of the frame.

### TECHNICAL FIELD

The disclosure relates generally to watercraft, and more particularly to battery enclosures for electric watercraft.

### BACKGROUND

The hull of a personal watercraft is a load bearing component that serves as the chassis of the watercraft. The hull must have a certain stiffness to meet structural requirements and preferably have a low mass to promote energy efficiency of the vehicle. Traditional methods of stiffening the hull of a watercraft include the use of stringers. However, stringers can be bulky and take away capacity for housing other components of the watercraft inside the interior volume of the hull. Improvement is desirable.

### SUMMARY

In one aspect, the disclosure describes an electric watercraft including a hull, a battery and an electric motor disposed within an interior space of the hull. The battery includes battery modules to power the electric motor. A frame supports the battery modules. The frame includes at least one brace extending between the port and starboard sides of the hull to strengthen the hull.

In another aspect, the disclosure describes an electric watercraft comprising:
a hull having a port side and a starboard side on opposite sides of a longitudinal central axis of the hull, the hull having an interior volume;
an electric motor for propelling the electric watercraft;
a battery operatively connected to drive the electric motor, the battery being disposed in the interior volume of the hull; and
a frame disposed in the interior volume of the hull and supporting the battery, the frame including a port member attached to the port side of the hull and a starboard member attached to the starboard side of the hull, the frame including a brace extending across the central axis of the hull and interconnecting the port member of the frame with the starboard member of the frame.

The frame may include a first mount attached to the port side of the hull and defining a load path between the port side of the hull and the frame, and a second mount attached to the starboard side of the hull and defining a load path between the starboard side of the hull and the frame.

The frame may include: two or more first mounts attached to the port side of the hull and defining two or more respective load paths between the port side of the hull and the frame, the two or more first mounts being longitudinally spaced apart relative to the central axis of the hull; and two or more second mounts attached to the starboard side of the hull and defining two or more respective load paths between the starboard side of the hull and the frame, the two or more second mounts being longitudinally spaced apart relative to the central axis of the hull.

The brace may be a first brace. The frame may include a second brace extending across the central axis of the hull and interconnecting the port member of the frame with the starboard member of the frame. The second brace may be disposed forward of the first brace relative to the central axis of the hull.

The port member, the starboard member, the first brace and the second brace may define a peripheral structure surrounding the battery.

The frame may include a third brace disposed between the first brace and the second brace along the central axis of the hull.

The frame may include a fourth brace extending across the central axis of the hull and interconnecting the port member of the frame with the starboard member of the frame.

The fourth brace may be disposed between the third brace and the second brace.

In some embodiments, an entirety of the battery may be disposed forward of the electric motor.

The electric watercraft may include a drive shaft drivingly connecting the electric motor to an impeller of the electric watercraft, at least a portion of the third brace may extend over the drive shaft of the electric watercraft.

The battery may include an aft battery module and a forward battery module. The forward battery module may be disposed forward of the aft battery module. The third brace may be disposed between the aft battery module and the forward battery module.

The aft battery module may be supported by the first brace member and the third brace.

The frame may exert a compressive force on the aft battery module.

The electric watercraft may include an enclosure for housing the battery. The enclosure may include the frame.

The enclosure may include a lower shell and an upper shell disposed above the lower shell. The frame may be disposed vertically between the lower shell and the upper shell.

An upper side of the frame may be in sealing engagement with the upper shell.

The upper side of the frame may be attached to the upper shell with a fastener. The upper side of the frame may be bonded to the upper shell with an adhesive.

A lower side of the frame may be in sealing engagement with the lower shell.

The frame and the lower shell may have a unitary construction.

A volume between the battery and the lower shell may contain foam.

The hull may include a transverse rib integrally formed therewith. The transverse rib may extend transversely to the central axis of the hull.

The hull may include a longitudinal rib integrally formed therewith. The longitudinal rib may extend longitudinally relative to the central axis of the hull.

The hull may be made of a composite material. The brace may be made of a metallic material.

The brace may be vertically above and spaced apart from an inner surface of the hull.

Embodiments may include combinations of the above features.

In another aspect, the disclosure describes an electric watercraft comprising:
a seat for accommodating a rider of the electric watercraft;
a deck supporting the seat;
a hull connected to the deck to define an interior volume therebetween, the hull having a port side and a starboard side on opposite sides of a longitudinal central axis of the hull;
an electric motor for propelling the electric watercraft;
a battery operatively connected to drive the electric motor, the battery being disposed in the interior volume; and
a battery enclosure disposed in the interior volume and housing the battery, the battery enclosure including:
a frame supporting the battery and extending across the central axis of the hull;
a first tab extending outwardly from the frame and attached to the port side of the hull; and
a second tab extending outwardly from the frame and attached to the starboard side of the hull.

The frame may include a peripheral structure surrounding the battery, the first tab and the second tab extending outwardly from the peripheral structure.

The frame may include a brace interconnecting portions of the peripheral structure on opposite sides of the central axis of the hull.

The brace may form a portion of the peripheral structure.

The battery enclosure may include a lower shell and an upper shell disposed above the lower shell. The frame may be disposed vertically between the lower shell and the upper shell.

Embodiments may include combinations of the above features.

In a further aspect, the disclosure describes a battery enclosure for a traction battery disposed inside a hull of an electric watercraft. The enclosure comprises:
a shell configured to house the traction battery; and
a frame to support the traction battery, the frame including:
a peripheral structure configured to extend around the traction battery; and
a plurality of mounting tabs extending outwardly from the peripheral structure and spaced apart around the peripheral structure, the mounting tabs being configured to attach the peripheral structure to a hull of the electric watercraft and define respective load paths between the hull and the peripheral structure.

The frame may include a brace extending across an interior region of the peripheral structure to interconnect portions of the peripheral structure.

The peripheral structure may be attached to and in sealing engagement with a lower shell and an upper shell of the enclosure.

The peripheral structure and the lower shell may have a unitary construction.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a perspective view of an exemplary electric personal watercraft including a battery enclosure as described herein;

FIG. 1B is a side elevation view of the electric personal watercraft of FIG. 1A with body panels and other components removed to schematically show internal components of the electric personal watercraft;

FIG. 2 is a perspective view of a hull of the electric personal watercraft of FIG. 1A with an exemplary battery enclosure disposed in an interior volume defined by the hull;

FIG. 3A is an enlarged perspective view of a forward portion of the battery enclosure and the hull;

FIG. 3B is another enlarged perspective view of a forward portion of the battery enclosure and the hull showing a frame of the battery enclosure attached to the hull;

FIG. 4 is a perspective cross-section of the battery enclosure taken in plane 4 of FIG. 3A;

FIG. 5 is a perspective cross-section of the battery enclosure taken in plane 5 of FIG. 3A;

FIG. 6 is a perspective view of part of the battery enclosure and the hull showing an interior of the battery enclosure;

FIG. 7 is a perspective view of an aft portion of an exemplary frame of the battery enclosure supporting two battery modules;

FIG. 8 is a perspective view of the frame of the battery enclosure shown in conjunction with an electric motor and drive shaft shown schematically;

FIG. 9 is a partial schematic longitudinal cross-sectional view of the battery enclosure with battery modules housed therein;

FIG. 10 is a perspective view of part of another exemplary battery enclosure; and

FIG. 11 is a cross-sectional view through the hull and a deck of the electric personal watercraft of FIG. 1A taken along line 11-11 in FIG. 1B showing another exemplary battery enclosure.

### DETAILED DESCRIPTION

The present disclosure relates to battery enclosures for electric (e.g., personal) watercraft. In some embodiments, the battery enclosures disclosed herein may serve functions of housing and supporting a traction battery of the electric watercraft while also providing structural support (e.g., stiffening) for a hull of the electric watercraft. For example, the enclosure may include a load-bearing frame that is attached to the hull to provide one or more load transfer paths between the hull and the load-bearing frame and provide stiffening of the hull.

The hull of a personal watercraft, which is essentially its chassis, needs a certain stiffness to meet regulations relating to the loads that the hull must be able to withstand during operation and during a drop test for example. The hull is a load-bearing component that also supports other components of the personal watercraft. For an electric personal watercraft, the torsional stiffness of the hull is also a factor in maintaining alignment of a drive shaft drivingly coupling an electric motor to an impeller of the electric personal watercraft. Torsional stiffness may also be a factor for manufacturing installment of an electric motor and a drive shaft to ensure appropriate alignment with an impeller.

While stringers may be used to improve the rigidity of a hull, they typically occupy a large portion of the interior of a hull. The traction battery of an electric watercraft may be a relatively large component that occupies a large portion of the interior volume of the hull of the watercraft, which may not leave much room for stringers. Other components disposed within the hull, such as an electric motor, may also inhibit the use of stringers.

Increasing the thickness of the hull is another means of increasing hull stiffness. However, increasing hull stiffness may also increase hull weight. In electric watercraft, increasing the weight of the hull may result in a corresponding decrease in range. As such, increasing the thickness of the hull may not be desirable.

In some embodiments, the battery enclosures disclosed herein provide means of stiffening a hull of a watercraft, including a hull of an electric watercraft. In some embodiments of the battery enclosures disclosed herein, the load-bearing frame of the battery enclosure may provide stiffness to the hull and may promote the use of a hull having a reduced weight by reducing the need for stringers and/or reducing the need for thicker hull wall thicknesses. In some embodiments, the battery enclosure and hull assembly may promote weight reduction, efficiency and extended range of the watercraft. In some embodiments, the reduced need for stringers may also provide more space in the interior volume of the hull to house the battery and/or other components of the watercraft. Aspects of various embodiments are described through reference to the drawings.

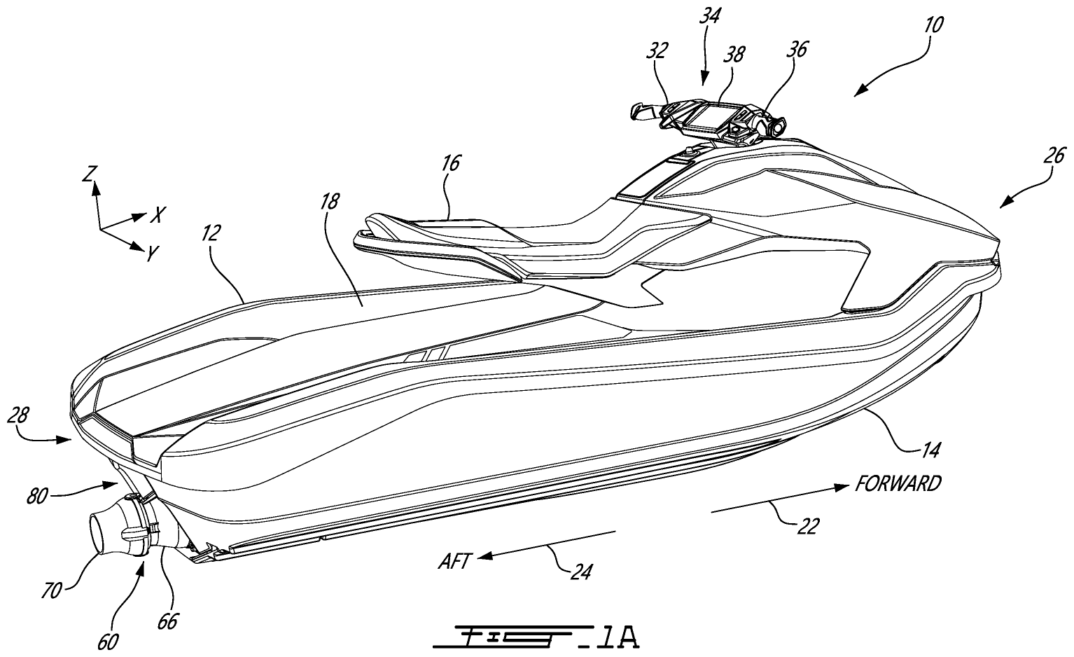

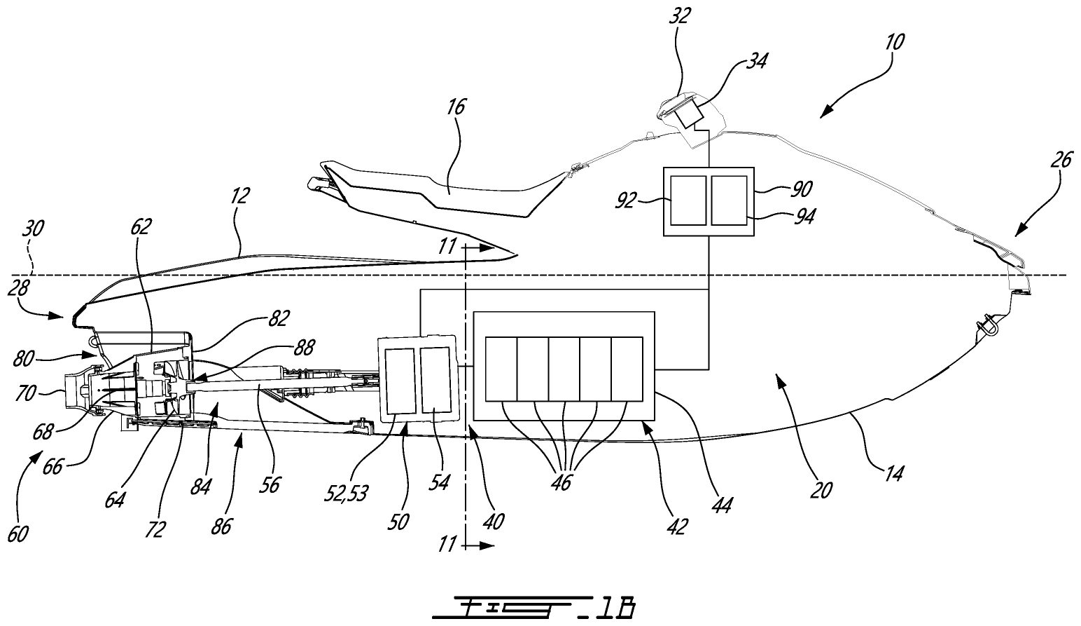

FIGS. 1A and 1B illustrate a perspective view and a longitudinal cross-section view of a watercraft 10, according to an embodiment. The watercraft 10 may be utilized for transporting one or more riders (e.g., an operator and optionally one or more passengers) over a body of water. The watercraft 10 may also be referred to as a “personal watercraft 10” or “PWC 10”. An upper portion of the watercraft 10 is formed of a deck 12 and a lower portion of the watercraft 10 is formed of a hull 14, which sits in the water. A (e.g., straddle) seat 16 is secured to the deck 12 (and in turn supported by the hull 14 via the deck 12) and sized for accommodating the riders of the watercraft 10. The deck 12 defines foot wells 18 on either side of the straddle seat 16. A steering mechanism 32 (e.g., a set of handlebars) is coupled to the deck 12 forward of the straddle seat 16. The steering mechanism 32 is rotatable by an operator of the watercraft 10 to steer the watercraft 10. The hull 14 and the deck 12 may be coupled together along a seam using adhesives and/or fasteners. When coupled together, the hull 14 and the deck 12 enclose an interior volume 20 of the watercraft 10 which provides buoyancy to the watercraft 10 and houses at least some components thereof.

The watercraft 10 may move along a forward direction of travel 22 and a rear or aft direction of travel 24 (shown in FIG. 1A). The forward direction of travel 22 is the direction along which the watercraft 10 travels in most instances when displacing. The aft direction of travel 24 is the direction along which the watercraft 10 displaces occasionally, such as when reversing. The watercraft 10 includes a bow 26 and a stern 28 defined with respect to the forward direction of travel 22 and the aft direction of travel 24, such that the bow 26 is positioned ahead of the stern 28 relative to the forward direction of travel 22, and that the stern 28 is positioned astern of the bow 26 relative to the aft direction of travel 24. Hull 14 of watercraft 10 may define a longitudinal central axis 30 (i.e., centerline) (shown in FIG. 1B and referred hereinafter as “central axis 30”) that extends between the bow 26 and the stern 28. Central axis 30 may be a line of symmetry between the port side and starboard side of hull 14. The port side and the starboard side of the watercraft 10 are defined on opposite lateral sides of the central axis 30. The positional descriptors “front”, “forward”, “aft”, “rear” and terms related thereto are used in the present disclosure to describe the relative position of components of the watercraft 10. For example, if a first component of the watercraft 10 is described herein as being in front of, or forward of, a second component, then the first component is closer to the bow 26 than the second component. Similarly, if a first component of the watercraft 10 is described herein as being aft of, or rearward of, a second component, then the first component is closer to the stern 28 than the second component. The watercraft 10 also includes a three-axes frame of reference that is displaceable with the watercraft 10, where the Z-axis is parallel to the vertical direction and defines heave and yaw (via rotation about the Z-axis) of the watercraft 10, the X-axis is parallel to the central axis 30 and defines surge and roll (via rotation about the X-axis) of the watercraft 10, and the Y-axis is perpendicular to both the X and Z-axes (extending laterally between the starboard and port sides) and defines sway and pitch (via rotation about the Y-axis) of the watercraft 10.

Referring to FIG. 1B, the watercraft 10 is electrically propelled by an electric powertrain 40. The electric powertrain 40 includes an electric battery 42 (also referred to as a “battery pack”), and an electric motor 50 (referred hereinafter as “motor 50”). Motor 50 may be configured to propel watercraft 10 and battery 42 may be a traction battery operatively connected to drive motor 50. The powertrain 40 is operatively connected to a drive shaft 56 and a jet propulsion system 60. The electric battery 42, motor 50 and drive shaft 56 may be located, in whole or in part, within the interior volume 20 of hull 14 and/or other internal volume of the watercraft 10. The interior volume 20 may also include other components suitable for use with the watercraft 10 such as storage compartments, a thermal management system, flotation foam and/or a charger, for example. In other embodiments, the watercraft 10 may also or instead be propelled by a powertrain including an internal combustion engine. For example, the motor 50 may also or instead be an internal combustion engine.

Battery enclosure 44 (referred hereinafter as “enclosure 44”) may house one or more battery modules 46 of battery 42. In the illustrated example, the battery modules 46 are arranged in a row and/or stacked within the enclosure 44. The enclosure 44 may support the battery modules 46 and protect the battery modules 46 from external impacts, water and/or other hazards or debris. Each battery module 46 may contain one or more battery cells, such as pouch cells, cylindrical cells and/or prismatic cells, for example. In some implementations, the battery cells are rechargeable lithium-ion battery cells. The battery 42 may also include other components to help facilitate and/or improve the operation of the battery 42, including temperature sensors to monitor the temperature of the battery cells, voltage sensors to measure the voltage of one or more battery cells, current sensors to implement coulomb counting to infer the state of charge (SOC) of the battery 42, and/or thermal channels that circulate a thermal fluid to control the temperature of the battery cells, for example. In some implementations, the battery 42 may output electric power at a voltage between 300 and 800 volts, for example. The watercraft 10 may also include a charger (not shown) to convert alternating current (AC) power from an external power source to direct current (DC) power to charge the battery 42. The charger may include, or be connected to, a charging port positioned forward of the straddle seat 16 to connect to a charging cable from an external power source. In some implementations, the charging port is covered by one or more protective flaps (e.g., made of plastic and/or rubber) to protect the charging port from water and other debris.

It should be noted that the battery 42 illustrated in FIG. 1B is shown by way of example. Other shapes, sizes and configurations of the battery 42 are contemplated. For example, while an entirety of battery 42 is shown forward of the motor 50 and drive shaft 56 in FIG. 1B, this need not always be the case. At least a portion of the battery 42 may also, or instead, extend overtop of the motor 50 and/or the drive shaft 56. Further, at least a portion of the battery 42 may be positioned on the port and starboard sides of the motor 50 and/or the drive shaft 56. In some implementations, the battery 42 may include multiple battery modules 46 that are interconnected via electrical cables, and housed in one or more enclosures 44. In some embodiments, battery 42 may include one or more battery modules 46 disposed aft of motor 50 and one or more battery modules 46 disposed forward of motor 50.

The motor 50 may convert the electric power output from the battery 42 into motive power to drive the jet propulsion system 60 of the watercraft 10. In the illustrated embodiment, the motor 50 is a permanent magnet synchronous motor having a rotor 52 and stator 53. The motor 50 also includes a power electronics module 54 (sometimes referred to as an inverter) to convert the DC power from the battery 42 to AC power having a desired voltage, current and waveform to drive the motor 50. In some implementations, the power electronics module 54 may include one or more capacitors to reduce the voltage variations between the high and low DC voltage leads, and one or more electric switches (e.g., insulated-gate bipolar transistors (IGBTs)) to generate the AC power. In some implementations, the motor 50 has a maximum output power of between 90 KW and 135 KW, for example. In other implementations, the motor 50 has a maximum output power greater than 135 kW.

In some implementations, the motor 50 may include sensors configured to sense one or more parameters of the motor 50. The sensors may be implemented in the rotor 52, the stator 53 and/or the power electronics module 54. The sensors may include a position sensor (e.g., an encoder) to measure a position and/or rotational speed of the rotor 52, and/or a speed sensor (e.g., a revolution counter) to measure the rotational speed of the rotor 52. Alternatively or additionally, the sensors may include a torque sensor to measure an output torque from the motor 50 and/or a current sensor (e.g., a Hall effect sensor) to measure an output current from the power electronics module 54.

Other embodiments of the motor 50 are also contemplated. For example, the power electronics module 54 may be integrated into the housing or casing of motor 50, as shown in FIG. 1B. However, the power electronics module 54 may also, or instead, be provided externally to the housing or casing of the motor 50. In some embodiments, the motor 50 may be a type other than a permanent magnet synchronous motor. For example, the motor 50 may instead be a brushless direct current motor.

The jet propulsion system 60 (also referred to as a “jet pump”) of the watercraft 10 creates a pressurized jet of water which provides thrust to propel the watercraft 10 through the water. A tunnel 80 formed at the stern 28 of the hull 14 at least partially accommodates the jet propulsion system 60. The jet propulsion system 60 includes a housing 62, which is a hollow body that delimits an interior channel or duct of the jet propulsion system 60. The housing 62 is coupled to the hull 14 at a rear wall 82 formed at a front end of the tunnel 80. The hull 14 also at least partially defines a water intake duct 84 having an inlet 86 provided at an underside of the hull 14 and an outlet 88 at the rear wall 82 to provide water to the jet propulsion system 60. In some implementations, a grate may be disposed over the inlet 86 to inhibit the intake of debris into the jet propulsion system 60.

The jet propulsion system 60 includes an impeller 64 positioned within the housing 62 to draw water through the intake duct 84. An inner wall of the housing 62 that surrounds the impeller 64 (referred to as a “wear ring”) may be a component that experiences wear and may be replaced. The impeller 64 is coupled to the motor 50 via the drive shaft 56. The drive shaft 56 extends through the hull 14, the intake duct 84 and the outlet 88 to couple to the impeller 64. The drive shaft 56 transfers motive power from the motor 50 to the impeller 64. The motor 50 is therefore drivingly engaged to the impeller 64. In the illustrated embodiment, the motor 50 is in a direct-drive arrangement with the impeller 64, such that a connection between the motor 50 and the impeller 64 is free of a gearbox. In other embodiments, a transmission may be used to provide a speed ratio between the motor 50 and the impeller 64.

Water ejected from the impeller 64 is directed through a venturi 66 (also referred to as a “nozzle”) formed by the housing 62 that further accelerates the water to provide additional thrust. The venturi 66 includes inwardly extending stator vanes 68 to convert the rotational flow of the water exiting the impeller 64 to thrust. The accelerated water jet is ejected from the venturi 66 via a pivoting steering nozzle 70 to provide a directionally controlled jet of water. The steering mechanism 32 may be mechanically coupled to the steering nozzle 70 to allow an operator to pivot the steering nozzle 70 and steer the watercraft 10. Pivoting the steering nozzle 70 horizontally to direct the water jet towards the port or starboard side of the watercraft 10 may turn the watercraft 10 to either side. The steering nozzle 70 may also pivot vertically to control the trim of the steering nozzle 70, thereby adjusting the running angle of the watercraft 10 in the water. Trimming the steering nozzle 70 upward helps to push the bow 26 of the watercraft 10 upward and may allow for the watercraft 10 to travel faster. Conversely, trimming the steering nozzle 70 downward helps to push the bow 26 of the watercraft 10 into the water which may allow for better navigation of the watercraft 10.

The watercraft 10 further includes a ride plate 72 that is coupled to the hull 14 below the jet propulsion system 60. The ride plate 72 may partially define the intake duct 84 and include a bottom surface that contributes to the ride and handling characteristics of the watercraft 10 in the water. In some implementations, the ride plate 72 may also include a heat exchanger forming part of a thermal management system of the watercraft 10. The heat exchanger may be a closed-loop heat exchanger having channels formed therein to carry a thermal fluid. The thermal fluid in the heat exchanger may be cooled by the water flowing past the ride plate 72, and then be pumped through thermal channels in the battery 42 and the motor 50, for example, to regulate the heat of those components during use. In some embodiments, the thermal management system may also include a heater (not shown) to heat the thermal fluid to provide heating to one or both of the battery 42 and the motor 50.

One or more controllers 90 (referred to hereinafter in the singular) and an instrument panel 34 are part of a control system for controlling operation of the watercraft 10. The instrument panel 34 allows an operator of the watercraft 10 to generate user inputs or instructions for the watercraft 10. The controller 90 is connected to the instrument panel 34 to receive the instructions therefrom and perform operations to implement those instructions. In the illustrated embodiment, the instrument panel 34 is provided on the steering mechanism 32 and the controller 90 is disposed within the interior volume 20, but this need not always be the case.

The instrument panel 34 includes an accelerator 36 (also referred to as a “throttle”) to allow an operator to control the thrust generated by the powertrain 40. For example, the accelerator 36 may include a lever to allow the operator to selectively generate an accelerator signal. The controller 90 is operatively connected to the accelerator 36 and to the motor 50 to receive the accelerator signal and produce a corresponding output from the motor 50. In some implementations, the accelerator signal is mapped to a rotational speed (e.g., revolutions per minute (RPM)) of the motor 50. When the controller 90 receives an accelerator signal from the accelerator 36, the controller 90 may map the accelerator signal to a rotational speed of the motor 50 and control the power electronics module 54 to produce that rotational speed using feedback from sensors in the motor 50. The mapping of the accelerator signal to an output from the motor 50 may be based on a performance mode of the watercraft 10 (e.g., whether the watercraft 10 is in a power-saving mode, a normal mode or a high-performance mode). In some examples, the mapping of the accelerator signal to an output from the motor 50 may be based on current operating conditions of the powertrain 40 (e.g., a temperature of the battery 42 and/or motor 50, a SOC of the battery 42, etc.). In still other examples, the mapping of the accelerator signal to an output from the motor 50 may be user configurable, such that a user may customize an accelerator position to motor output mapping.

The watercraft 10 may be capable of generating reverse thrust to slow down the watercraft 10 when traveling in the forward direction of travel 22 and/or to propel the watercraft 10 in the reverse direction of travel 24. The instrument panel 34 may include a distinct user input device (e.g., a brake lever and/or reverse button) to instruct the controller 90 to generate reverse thrust. In some implementations, reverse thrust is generated by reversing the direction of the motor 50, which draws water in from the steering nozzle 70 and expels the water out from the inlet 86 of the intake duct 84. Alternatively, reverse thrust may be generated using a reverse bucket or deflector gate that deflects the water jet from the venturi 66 forwards, thereby generating reverse thrust.

In addition to the accelerator 36, the instrument panel 34 may include other user input devices (e.g., levers, buttons and/or switches) to control various other functionality of the watercraft 10. These user input devices may be connected to the controller 90, which executes the instructions received from the user input devices. Non-limiting examples of such user input devices include a device to switch the watercraft 10 between different vehicle states (e.g., “off”, “neutral” and “drive” states), a device to switch the watercraft 10 between different performance modes, and a device to adjust the trim of the steering nozzle 70. The instrument panel 34 also includes a display screen 38 (shown in FIG. 1A) connected to the controller 90 that displays information pertaining to the watercraft 10 to an operator. Non-limiting examples of such information include the current state of the watercraft 10, the current performance mode of the watercraft 10, the speed of the watercraft 10, the SOC of the battery 42, the RPM of the motor 50, and the power output from the motor 50. The display screen 38 may include a liquid crystal display (LCD) screen, thin-film-transistor (TFT) LCD screen, light-emitting diode (LED) or other suitable display device. In some embodiments, display screen 38 may be touch-sensitive to facilitate operator inputs.

The controller 90 may also control additional functionality of the watercraft 10. For example, the controller 90 may control a battery management system (BMS) to monitor the SOC of the battery 42 and manage charging and discharging of the battery 42. In another example, the controller 90 may control a thermal management system to manage a temperature of the battery 42 and/or the motor 50 using a thermal fluid cooled by a heat exchanger in the ride plate 72. Temperature sensors in the battery 42 and/or the motor 50 may be connected to the controller 90 to monitor the temperature of these components.

The controller 90 includes one or more data processors 92 (referred hereinafter as “processor 92”) and non-transitory machine-readable memory 94. The memory 94 may store machine-readable instructions which, when executed by the processor 92, cause the processor 92 to perform any computer-implemented method or process described herein. The processor 92 may include, for example, any type of general-purpose microprocessor or microcontroller, a digital signal processing (DSP) processor, an integrated circuit, an application-specific integrated circuit (ASIC), a field programmable gate array (FPGA), a reconfigurable processor, other suitably programmed or programmable logic circuits, or any combination thereof. The memory 94 may include any suitable machine-readable storage medium such as, for example, an electronic, magnetic, optical, electromagnetic, infrared, or semiconductor system, apparatus, or device, or any suitable combination thereof. The memory 94 may be located internally and/or externally to the controller 90.

Although the controller 90 is shown as a single component in FIG. 1B, this is only an example. In some implementations, the controller 90 may include multiple controllers distributed at various locations in the watercraft 10. For example, the controller 90 may include a vehicle control unit (also referred to as a “body controller”) that is responsible for interpreting the inputs from various other controllers in the watercraft 10. Non-limiting examples of these other controllers include a motor controller that is part of the power electronics module 54 and a battery management controller that is part of the battery 42. Optionally, separate battery management controllers may be implemented in the each of the battery modules 160 to form a distributed battery management system.

Systems and methods are described and shown in the present disclosure in relation to the watercraft 10, but aspects of the present disclosure may also be applied to other types of watercraft, including single and multiple passenger boats, for example.

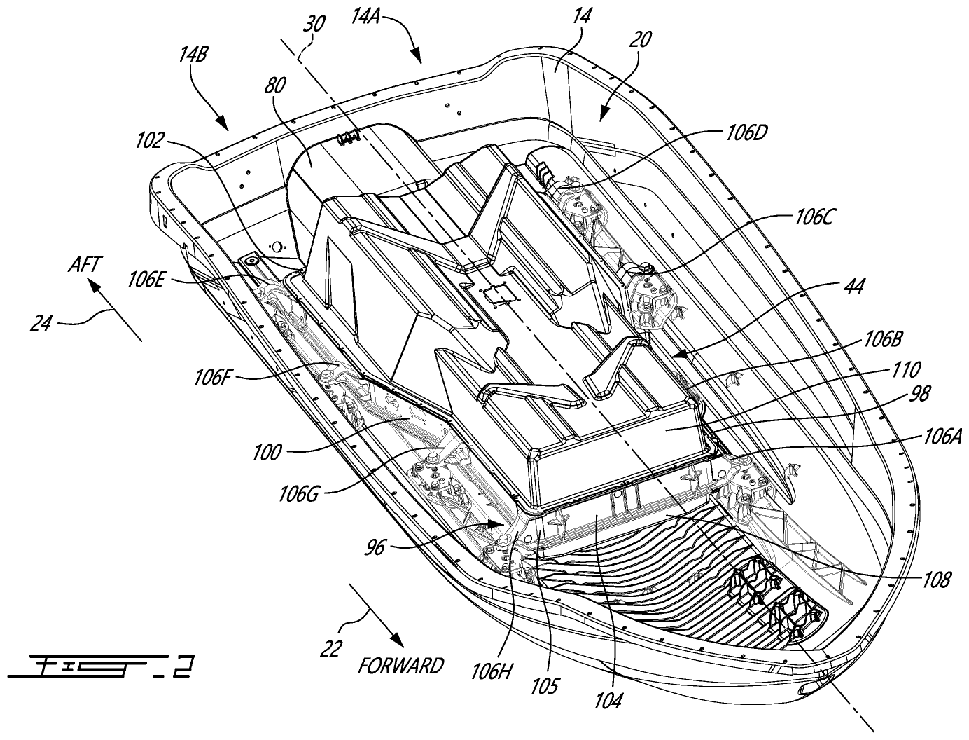

FIG. 2 is a perspective view of hull 14 of watercraft 10 with an exemplary enclosure 44 disposed in interior volume 20 defined by hull 14. Hull 14 may have port side 14A and starboard side 14B on opposite lateral sides of central axis 30 of hull 14 (e.g., on opposite sides of a vertical plane containing central axis 30). Battery 42 may be housed inside of enclosure 44 and in interior volume 20 of hull 14. Battery 42 may be operatively connected to drive motor 50 for propelling watercraft 10.

Enclosure 44 may include structural frame 96 disposed in interior volume 20 of hull 14. Frame 96 may be configured to support battery 42 and also provide stiffening of hull 14. Frame 96 may include port member 98 attached to port side 14A of hull 14 and starboard member 100 attached to starboard side 14B of hull 14. Port member 98 and starboard member 100 may be longitudinal members extending (e.g., partially or entirely) substantially parallel to central axis 30. In some embodiments, frame 96 may include aft brace 102 extending between port member 98 and starboard member 100. In some embodiments, frame 96 may include forward brace 104 extending between port member 98 and starboard member 100. Forward brace 104 may be being disposed forward of aft brace 102 relative to central axis 30 of hull 14. Aft brace 102 and forward brace 104 may be brace members, cross members or cross braces extending substantially transversely within hull 14 (i.e., substantially perpendicular to central axis 30). Aft brace 102 and forward brace 104 may structurally interconnect port member 98 and starboard member 100. In some embodiments, forward brace 104 may be shorter than aft brace 102 depending on the shape of hull 14 and the position and size of frame 96 inside of hull 14. In some embodiments, port member 98, starboard member 100, aft brace 102 and forward brace 104 may be structurally attached together to define peripheral structure 105 that surrounds battery 42 and that extends across central axis 30 of hull 14.

Frame 96 may be attached to hull 14 at a plurality of discrete and spaced apart mounting locations via suitable mounts 106A-106H to define discrete load paths between different portions of hull 14 and frame 96. For example, one or more (e.g., four) mounts 106A-106D may be attached to port side 14A of hull 14 and may define respective load paths between port side 14A of hull 14 and port member 98 of frame 96. Optionally, mounts 106A-106D may be part of port member 98. In some embodiments, two or more mounts 106A-106D may be attached to port side 14A of hull 14 and may be longitudinally spaced apart relative to central axis 30 of hull 14. In some embodiments, one or more mounts 106E-106H may be attached to starboard side 14B of hull 14 and may define respective load paths between starboard side 14B of hull 14 and starboard member 100 of frame 96. Optionally, mounts 106E-106H may be part of starboard member 100. In some embodiments, two or more mounts 106E-106H may be attached to starboard side 14B of hull 14 and may be longitudinally spaced apart relative to central axis 30 of hull 14.

The stiffness of hull 14 may be based, at least in part, on the geometry and material of hull 14. Frame 96 may support or stiffen hull 14. For example, the combination of hull 14 and frame 96 may contribute positively to the stiffness of watercraft 10. Both hull 14 and frame 96 may add to the overall stiffness of watercraft 10. Frame 96 may be considered a skeleton of watercraft 10, adding structure and support to hull 14. In this way, frame 96 may increase or otherwise contribute to the effective stiffness of hull 14 in watercraft 10.

In some embodiments, port member 98 and starboard member 100 may contribute at least to longitudinal stiffness. Similarly, aft brace 102 and forward brace 104 may contribute at least to transverse stiffness. In this way, aft brace 102 and/or forward brace 104 may provide bracing between port sides 14A and starboard side 14B of hull 14. Port member 98, starboard member 100, aft brace 102 and/or forward brace 104 may also provide torsional and bending stiffness to hull 14. In some embodiments, the addition of frame 96 may increase stiffness at various points of hull 14 by a factor of two or more.

Frame 96 may be rigid relative to hull 14 and/or other portions of enclosure 44 (e.g., lower shell 108 and/or upper shell 110 discussed below) to improve the overall rigidity of the hull 14. In various embodiments, port member 98, starboard member 100, aft brace 102 and/or forward brace 104 may be made from one or more relatively rigid material(s). For example, port member 98, starboard member 100, aft brace 102 and forward brace 104 may be made from a suitable metallic material (e.g., aluminum, steel), plastic material (e.g., glass fiber reinforced thermoplastic resin) or composite material (e.g., long fiber thermoset resin). Port member 98, starboard member 100, aft brace 102 and forward brace 104 may be fabricated as separate components that are subsequently assembled (e.g., fastened, welded, bonded) together to define peripheral structure 105. Alternatively, port member 98, starboard member 100, aft brace 102 and forward brace 104 may be made as an integrally formed single component having a unitary (e.g., monolithic) construction. In various embodiments, port member 98, starboard member 100, aft brace 102 and forward brace 104 may be made by extrusion, casting, hydroforming and/or injection molding for example.

Frame 96 may have longitudinal and lateral spans configured to provide stiffening to a significant portion of hull 14. However, frame 96 might not stiffen the entire longitudinal and/or lateral span of hull 14. For example, frame 96 might have a length along central axis 30 that is less than the length of hull 14. This might reduce the size and weight of frame 96, and may also allow for some deformation of hull 14 in the presence of impacts. For example, allowing for some deformation of hull 14 towards bow 26 may help absorb bumps and other shocks during use of watercraft 10. This may provide a more comfortable ride for an operator and reduce loads on some components of watercraft 10.

The size and location of frame 96 may be selected for weight distribution (i.e., effect on the center of gravity from the location of battery modules 46) and/or where the added stiffness is most needed (e.g., to maintain alignment of drive shaft 56). For example, in some embodiments, the peripheral structure 105 cooperatively defined by port member 98, starboard member 100, aft brace 102 and forward brace 104 may have an overall length along central axis 30 that is between 25% and 55% of an overall length of hull 14 along central axis 30. In some embodiments, the overall length of peripheral structure 105 may be between 30% and 50% of the overall length of hull 14. In some embodiments, the overall length of peripheral structure 105 may be between 35% and 45% of the overall length of hull 14. In some embodiments, the overall length of the peripheral structure 105 may be between 40% and 45% of the overall length of hull 14. In some embodiments, peripheral structure 105 may have an overall width transverse to central axis 30 that is between 35% and 75% of an overall width (i.e., beam) of hull 14. In some embodiments, the overall width of peripheral structure 105 may be between 45% and 65% of the overall width of hull 14. In some embodiments, the overall width of peripheral structure 105 may be between 50% and 60% of the overall width of hull 14. In some embodiments, the overall width of peripheral structure 105 may be between 55% and 60% of the overall width of hull 14.

Enclosure 44 may include lower shell 108 configured to house a lower portion of battery 42, and upper shell 110 configured to house an upper portion of battery 42. Peripheral structure 105 of frame 96 may be configured to extend around battery 42 and be disposed vertically between lower shell 108 and upper shell 110. In other words, peripheral structure 105 may be disposed above lower shell 108, and upper shell 110 may be disposed above peripheral structure 105 and above lower shell 108. Lower shell 108 and upper shell 110 may be covers that provide a sealing functionality and which are sealingly attached to peripheral structure 105. In some embodiments, enclosure 44 may be fluid sealed to prevent liquid (e.g., water) and/or gas to enter or exit enclosure 44. In various embodiments, lower shell 108 and/or upper shell 110 may also serve a load bearing (i.e., structural) function for supporting battery 42 and/or stiffening hull 14. Alternatively, lower shell 108 and/or upper shell 110 may provide solely a sealing or housing functionality for battery 42. In some embodiments, lower shell 108 and upper shell 110 may be made from a suitable (e.g., fiber-reinforced) polymeric material using injection molding for example.

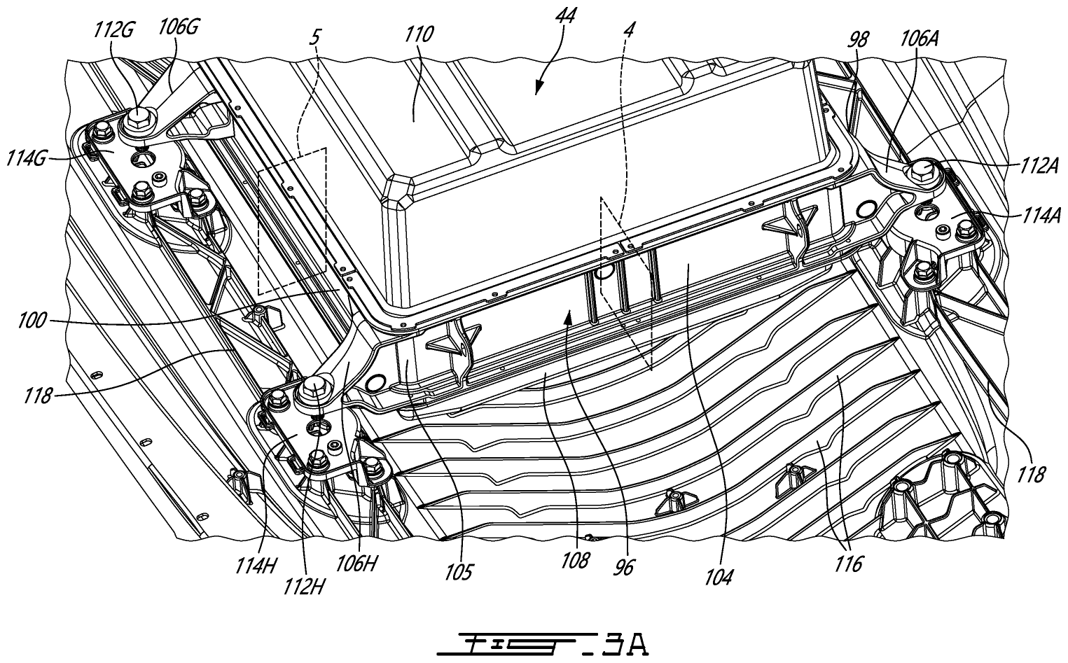

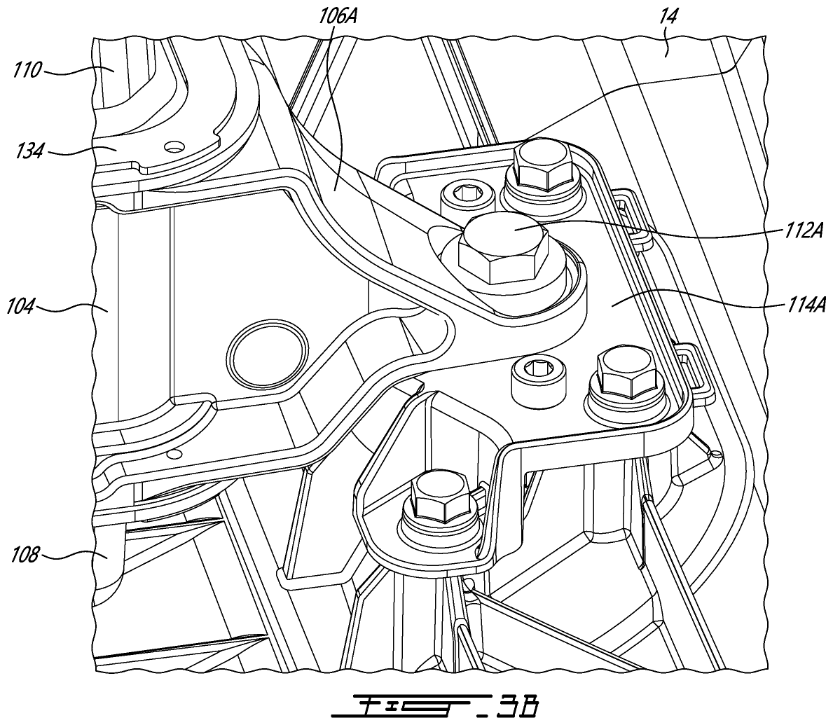

FIGS. 3A and 3B are enlarged perspective views of a forward portion of enclosure 44 and an adjacent portion of hull 14. FIGS. 3A and 3B illustrate how frame 96 may be attached (e.g., fastened) to hull 14. FIG. 3A shows mounts 106A, 106G and 106H of frame 96 being disassembled and lifted from hull 14 for clarity in illustrating the attachment means between frame 96 and hull 14. FIG. 3B shows mount 106A being attached to hull 14 via cooperating mounting pad 114A. In various embodiments, mounts 106A-106H may all have uniform configuration or some of mounts 106A-106H may have a different configuration than other mounts 106A-106H. In various embodiments, each mount 106A-106H may include a respective mounting tab or similar appendage extending outwardly from peripheral structure 105. The mounting tabs may be configured to facilitate the attachment of peripheral structure 105 to hull 14 and define respective load paths between hull 14 and peripheral structure 105. Mounts 106A-106H may be attached (e.g., welded to, fastened to, integrally formed with) peripheral structure 105. Mounts 106A-106H may extend outwardly from (i.e., away from an interior region surrounded by) peripheral structure 105. Mounts 106A-106H may be spaced apart around peripheral structure 105. Other configurations of mounts 106A-106H such as brackets and/or flanges may be suitable.

In reference to FIG. 3A, each mount 106A, 106G and 106H may have one or more holes formed therethrough to accommodate the passage of one or more respective fasteners (e.g., bolts) 112A, 112G and 112H. Mounts 106A, 106G and 106H may interface with respective mounting brackets or pads 114A, 114G and 114H, which may be part of hull 14 or attached (e.g., fastened) to hull 14. For examples, fasteners 112A, 112G and 112H may be engaged with respective threaded receptacles of (e.g., metallic) mounting pads 114A, 114G and 114H to attach frame 96 to hull 14 and establish suitable respective load paths between hull 14 and frame 96. In some embodiments, the attachment of frame 96 to hull 14 may be established via substantially rigid connections. In some embodiments, the attachment of frame 96 to hull 14 may be established via vibration isolators or dampeners (i.e., soft mounts).

In some embodiments, the use of frame 96 to stiffen hull 14 may reduce or eliminate the need for conventional stringers. However, in some embodiments, hull 14 may include stiffening ribs 116, 118. The combination of frame 96 and stiffening ribs 116, 118 may improve rigidity and enable reduced thicknesses of hull 14, which may reduce an overall weight of watercraft 10. In some embodiments, hull 14 may be made using a molding process whereby stiffening ribs 116, 118 may be integrally formed as part of hull 14 during the same molding process to have a unitary (e.g., monolithic) construction with hull 14. In some embodiments, stiffening ribs 116, 118 may be manufactured separately and subsequently attached (e.g., bonded, fastened) to a skin of hull 14. In some embodiments, hull 14 may be made of a fiber-reinforced composite material such as fiberglass or a sheet molding compound (SMC) for example. In some embodiments, hull 14 may include one or more transverse stiffening ribs 116 and/or one or more longitudinal stiffening ribs 118. Stiffening ribs 116, 118 may extend into interior volume 20 of hull 14 from an inner side of the skin of hull 14 but may be generally less bulky than conventional stringers.

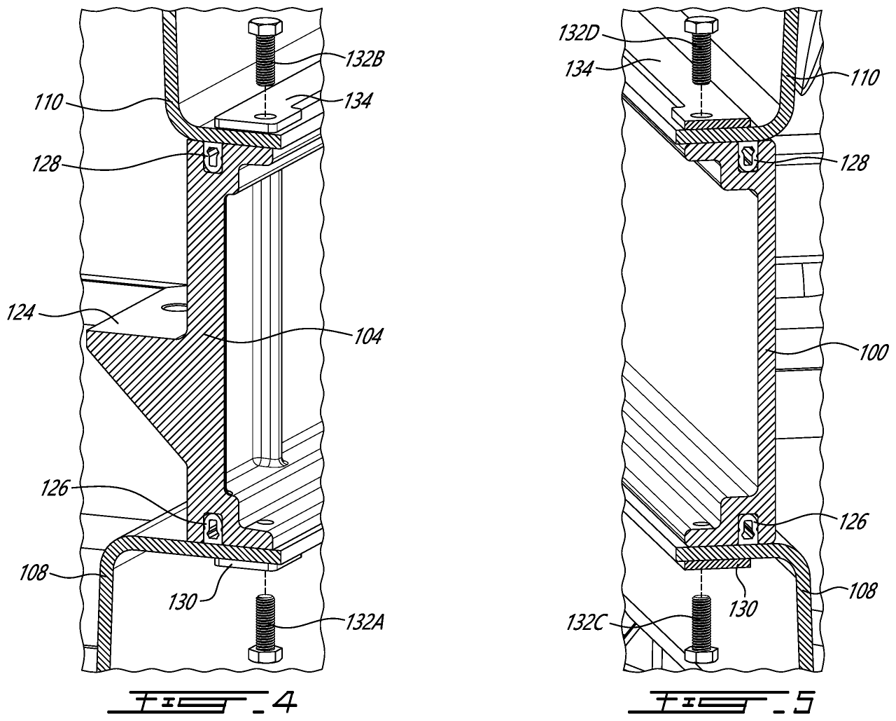

FIG. 4 is a perspective section view of enclosure 44 taken in plane 4 of FIG. 3A extending through forward brace 104 of peripheral structure 105 of frame 96. In some embodiments, aft brace 102 may have a same or a different cross-sectional profile as forward brace 104. In some embodiments, forward brace 104 may have a generally C-shaped cross-sectional profile providing upper and lower flanges for interfacing with upper shell 110 and lower shell 108 respectively. Such a cross-sectional profile may improve the rigidity of forward brace 104. Alternatively, forward brace 104 may be an I-beam or have another suitable cross-sectional profile. In some embodiments, forward brace 104 may also include shelf 124 attached to an inner side of forward brace 104 for supporting part of battery 42.

In some embodiments, peripheral structure 105 is fastened to and in sealing engagement with lower shell 108 and upper shell 110. For example, a lower side of forward brace 104 may be in sealing engagement with lower shell 108 via lower seal 126 (e.g., O-ring, gasket) which may be compressed between forward brace 104 and lower shell 108. Lower shell 108 may be attached to forward brace 104 via one or more suitable fasteners 132A (e.g., bolts, rivets) extending through (e.g., metallic) lower retainer bar 130 and being engaged with a threaded receptacle formed in forward brace 104 for example. Instead or in addition to fasteners 132A, lower shell 108 may be attached to forward brace 104 using a suitable structural adhesive which may adhesively bond lower shell 108 to forward brace 104 and also provide sealing by filling gaps between lower shell 108 and forward brace 104. In some embodiments, peripheral structure 105 may instead be integrally formed (e.g., molded) with lower shell 108 to have a unitary construction with lower shell 108.

An upper side of forward brace 104 may be in sealing engagement with upper shell 110 via upper seal 128 (e.g., O-ring, gasket) which may be compressed between forward brace 104 and upper shell 110. Upper shell 110 may be attached to forward brace 104 via one or more suitable fasteners 132B (e.g., bolts, rivets) extending through (e.g., metallic) upper retainer bar 134 and being engaged with a threaded receptacle formed in forward brace 104 for example. Instead or in addition to fasteners 132B, upper shell 110 may be attached to forward brace 104 using a suitable structural adhesive which may adhesively bond upper shell 110 to forward brace 104 and also provide sealing by filling gaps between upper shell 110 and forward brace 104.

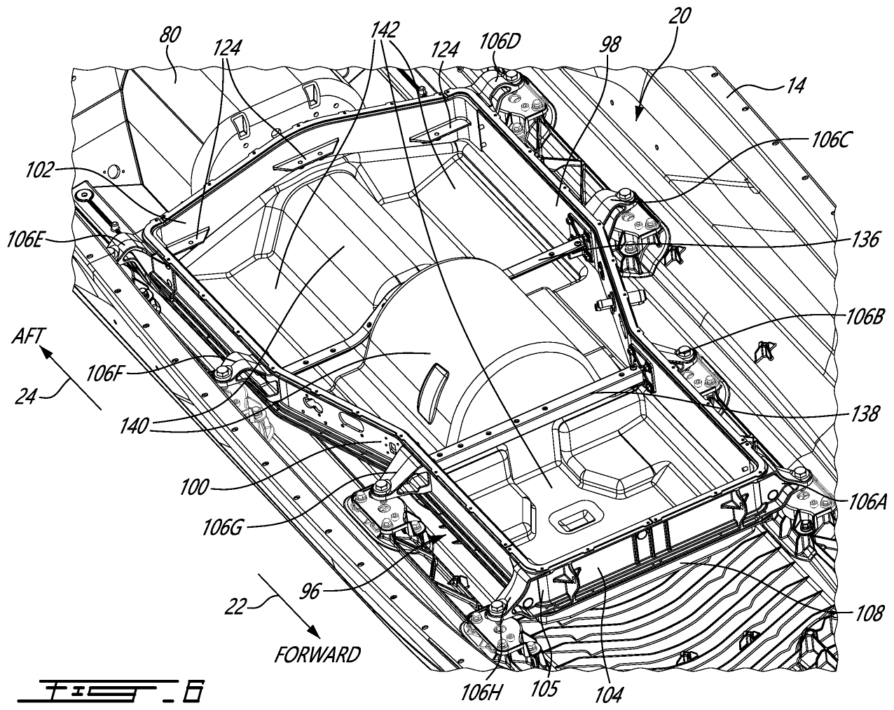

FIG. 5 is a perspective section view of enclosure 44 taken in plane 5 of FIG. 3A extending through starboard member 100 of peripheral structure 105 of frame 96. In some embodiments, port member 98 may have a same or a different cross-sectional profile as starboard member 100. In some embodiments, starboard member 100 may have a generally C-shaped cross-sectional profile providing upper and lower flanges for interfacing with upper shell 110 and lower shell 108 respectively. Alternatively, starboard member 100 may be an I-beam or have another suitable cross-sectional profile providing sufficient rigidity.

A lower side of starboard member 100 may be in sealing engagement with lower shell 108 via lower seal 126 (e.g., O-ring, gasket) which may be compressed between starboard member 100 and lower shell 108. Lower shell 108 may be attached to starboard member 100 via one or more suitable fasteners 132C (e.g., bolts, rivets) extending through lower retainer bar 130 and being engaged with a threaded receptacle formed in starboard member 100 for example. Instead or in addition to fasteners 132C, lower shell 108 may be attached to starboard member 100 using a suitable structural adhesive which may adhesively bond lower shell 108 to starboard member 100 and also provide sealing by filling gaps between lower shell 108 and starboard member 100.

An upper side of starboard member 100 may be in sealing engagement with upper shell 110 via upper seal 128 (e.g., O-ring, gasket) which may be compressed between starboard member 100 and upper shell 110. Upper shell 110 may be attached to starboard member 100 via one or more suitable fasteners 132D (e.g., bolts, rivets) extending through upper retainer bar 134 and being engaged with a threaded receptacle formed in starboard member 100 for example. Instead or in addition to fasteners 132D, upper shell 110 may be attached to starboard member 100 using a suitable structural adhesive which may adhesively bond upper shell 110 to starboard member 100 and also provide sealing by filling gaps between upper shell 110 and starboard member 100.

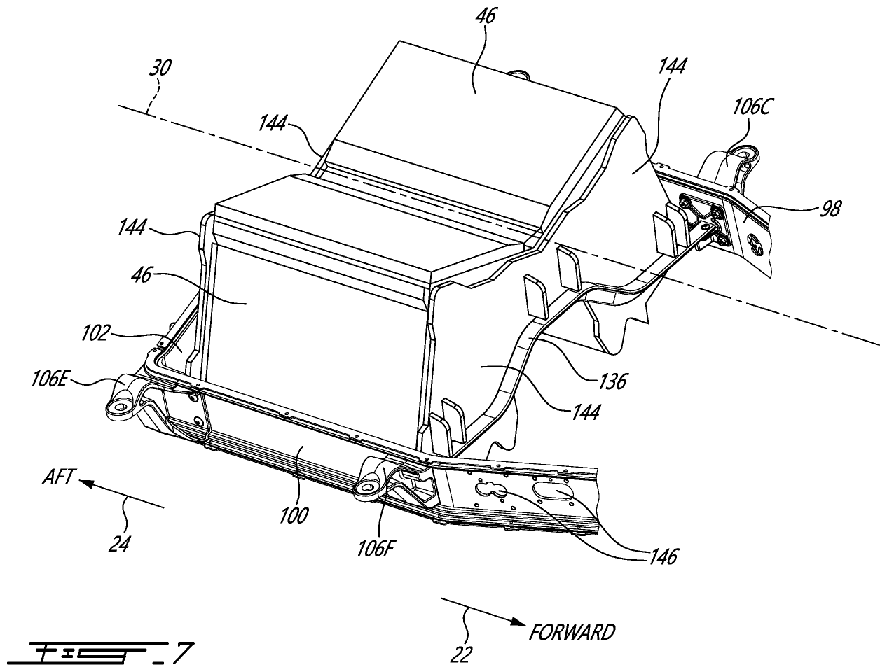

FIG. 6 is a perspective view of part of enclosure 44 and hull 14 showing an interior of enclosure 44. Specifically, upper shell 110 has been omitted from FIG. 6. In some embodiments, frame 96 may include one or more internal braces 136, 138 having the form of brace members, cross members or cross braces (e.g., straight or curved bars) extending across central axis 30 of hull 14 and interconnecting port member 98 with starboard member 100 via fasteners, welds or other structural connections. Internal braces 136, 138 may be separate from peripheral structure 105 and may extend across an interior region of peripheral structure 105 to interconnect portions of the peripheral structure 105 on opposite sides of central axis 30. Accordingly, internal braces 136, 138 may be disposed between aft brace 102 and forward brace 104. Internal braces 136, 138 may be made from the same material as peripheral frame 105 or from other structural material. Internal braces 136, 138 may provide stiffening of frame 96 and hence of hull 14 as well.

In some embodiments, frame 96 may include first internal brace 136 and second internal brace 138. Second internal brace 138 may be disposed forward of first internal brace 136 relative to central axis 30. For example, second internal brace 138 may be disposed between first internal brace 136 and forward brace 104.

In some embodiments, lower shell 108 may be disposed over other components such as motor 50 and drive shaft 56 for example. For efficient packaging inside of hull 14, lower shell 108 may be formed with contours to accommodate the other components that are under lower shell 108. For example, lower shell 108 may includes one or more humps 140 for accommodating motor 50 and drive shaft 56. First internal brace 136 may also be curved to extend over drive shaft 56. Lower shell 108 may also include one or more pockets 142 for receiving respective battery modules 46. Pockets 142 may be recesses or receptacles formed in lower shell 108. In some embodiments, two battery modules 46 may be housed in an aft portion of enclosure 44 and two battery modules 46 may be housed in a forward portion of enclosure 44. Peripheral structure 105 may surround all four battery modules 46. Aft brace 102 and forward brace 104 may each include one or more shelves 124 extending inwardly to support battery modules 46.

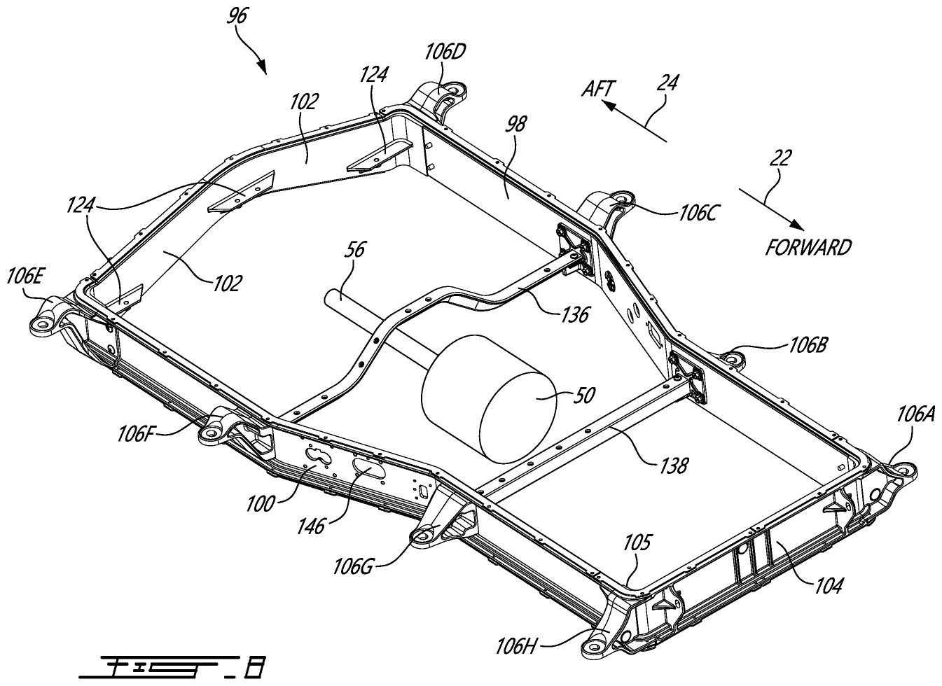

FIG. 7 is a perspective view of an aft portion of frame 96 of battery enclosure 44 supporting two battery modules 46. The two battery modules 46 may be supported by aft brace 102 (e.g., via one or more shelves 124 shown in FIG. 6) and by first internal brace 136 via respective pairs of end plates 144, which may be considered part of frame 96. In some embodiments, end plates 144 may be disposed at each end of battery modules 46 and connected using fasteners to compress battery modules 46 therebetween. As illustrated, end plates 144 are also connected to aft brace 102 and first internal brace 136 to support battery modules 46. In some embodiments, battery modules 46 may be housed in a tilted orientation for packaging efficiency to allow room for drive shaft 56, motor 50 and/or jet propulsion system 60 disposed under lower shell 108 for example. For example, the two battery modules 46 may be disposed side by side on opposite sides of central axis 30 and tilted toward each other to make room for drive shaft 56 to extend between the two battery modules 46.

In some embodiments, peripheral structure 105 may include one or more holes 146 formed therethrough to permit the passage of fluid conduit(s) and/or electric conductors through enclosure 44. Such conduits/conductors may be routed through peripheral frame 105 in a sealed manner using grommets or other suitable feedthrough devices.

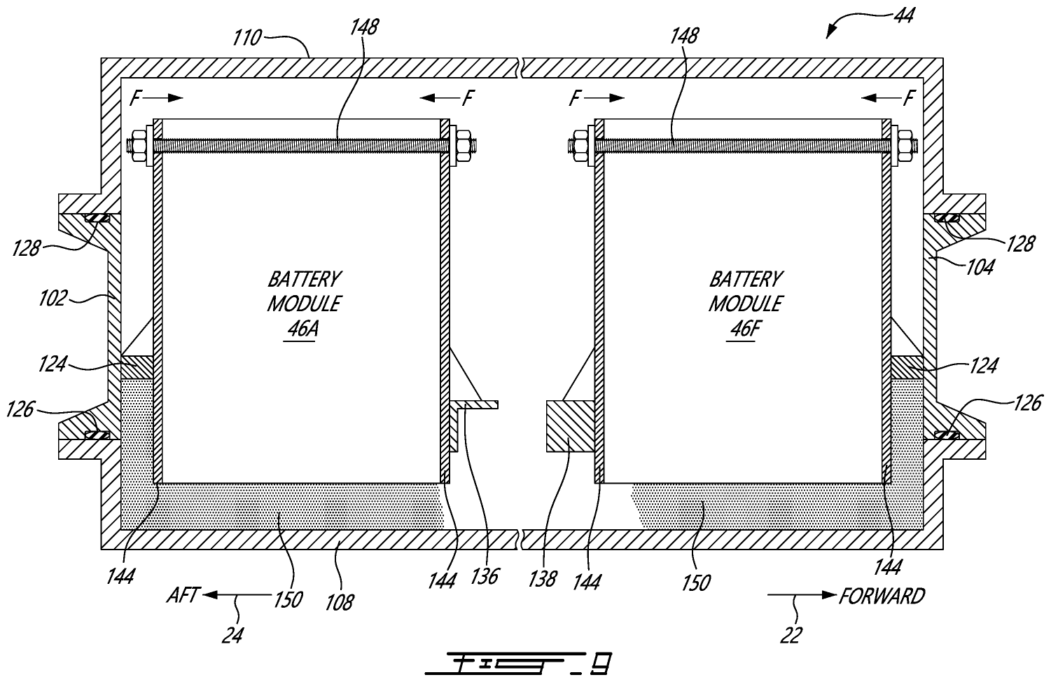

FIG. 8 is a perspective view of frame 96 of enclosure 44 shown in conjunction with motor 50 and drive shaft 56 shown schematically. Motor 50 and drive shaft 56 may be disposed under lower shell 108, which is omitted from FIG. 8. In other words, motor 50 and drive shaft 56 may be disposed between lower shell 108 and an inner surface of hull 14. Drive shaft 56 may drivingly connect motor 50 to impeller 64 (shown in FIG. 1B) of watercraft 10. Motor 50 may be disposed longitudinally between first internal brace 136 and second internal brace 138. Accordingly, first internal brace 136 and/or aft brace 102 may extend over drive shaft 156. First internal brace 136 and/or aft brace 102 may be shaped to include an upward deviation to accommodate the passage of drive shaft 56.

As shown in FIG. 8, aft brace 102, forward brace 104, first internal brace 136 and/or second internal brace 138 may form a brace structure (or simply a brace) between port member 98 and starboard member 100. In some embodiments, a brace may be a structure connected between port side 14A and starboard side 14B of hull 14 to contribute to the stiffness and/or rigidity of hull 14. For example, such a brace may provide torsional, compressive and tensile rigidity to hull 14, at least in the transverse direction. A brace may also support battery modules 46. In this way, a brace may have a dual purpose within hull 14.

In the example of frame 96, each of aft brace 102, forward brace 104, first internal brace 136 and second internal brace 138 are positioned vertically above and spaced apart from a lower inner surface of hull 14. In this way, frame 96 may provide a triangulated brace or frame to better manage loads within hull 14. Increasing the distance between a brace member and the lower inner of hull 14 may increase the effective stiffness of hull 14 in watercraft 10.

In some embodiments, positioning first internal brace 136 and/or aft brace 102 above, and proximate to, drive shaft 56 may provide additional stiffness around drive shaft 56. This additional stiffness may help maintain alignment of drive shaft 56 with impeller 64, which may provide a more efficient operation of jet propulsion system 60 and reduce wear on various drivetrain components. Further, maintaining alignment of drive shaft 56 may help reduce water ingress through the passage where drive shaft 56 exits hull 14. The passage may be provided with a carbon seal to reduce water ingress, but misalignment of drive shaft 56 may compromise operation of the seal. Further, positioning battery modules 46 supported by first internal brace 136 and/or aft brace 102 next to drive shaft 56 may help move the center of gravity of watercraft 10 towards stern 28, which may provide more efficient travel of watercraft 10 in the water.

While frame 96 is illustrated as having four braces in FIG. 8, a structural battery frame for a watercraft may have any number of braces (i.e., one or more braces). In some embodiments, first internal brace 136 and second internal brace 138 may be omitted, and aft brace 102 and forward brace 104 may support battery modules 46 and stiffen hull 14. In some embodiments, only a single brace member may be included in frame 96.

Although aft brace 102, forward brace 104, first internal brace 136 and second internal brace 138 are illustrated as extending substantially transversely (e.g., parallel to the Y axis) within hull 14, this is only an example. In some embodiments, one or more braces may be orientated at an angle between the transverse and longitudinal directions of hull 14. Alternatively, or additionally, one or more braces may be orientated at an angle (e.g., obliquely) between the transverse and vertical directions of hull 14. For example, members of a brace may be arranged in an X-shape, where two points of the X-shape are connected to port side 14A and the other two points are connected to the starboard side 14B. As another example, braces may be arranged in a diamond shape. Other orientations and shapes of braces may be used.

In some embodiments, the shapes and sizes of individual brace members of a frame may differ from those shown in FIG. 8. For example, braces may be implemented in any of a variety of configurations including beams, plates, tubes, rods and the like.

Similar variations may apply to port member 98 and/or starboard member 100 as well. In some embodiments, port member 98 and/or starboard member 100 might not extend substantially parallel to central axis 30. Other shapes of port member 98 and/or starboard member 100 are also contemplated, including beams, plates, tubes, rods and the like.

In some embodiments, port member 98 and/or starboard member 100 might have a reduced length such that it/they do not extend the longitudinal length of enclosure 44. Alternatively, port member 98 and/or starboard member 100 may be omitted entirely. With the reduction/omission of port member 98 and/or starboard member 100, frame 96 might not be a unitary structure and may instead be formed from discrete members that are attached to hull 14 separately. As such, frame 96 need not include a complete peripheral structure 105 as shown in FIG. 6. Lower shell 108 and/or upper shell 110 may fill in gaps in enclosure 44 left by the reduction/omission of port member 98 and/or starboard member 100. In some embodiments, brace members, including any one or more of aft brace 102, forward brace 104, first internal brace 136 and second internal brace 138, may be directly connected to respective pairs of mounts 106A-106H. In this way, mounts 106A-106H themselves may be port and starboard members of frame 96.

In an embodiment, frame 96 might include only one brace (e.g., first internal brace 136) and two mounts (e.g., mounts 106C, 106F) to connect the brace to port side 14A and starboard side 14B of hull 14. The mounts may form port and starboard members of frame 96, and the brace may strengthen hull 14. Battery modules may be supported by the brace and/or the mounts.

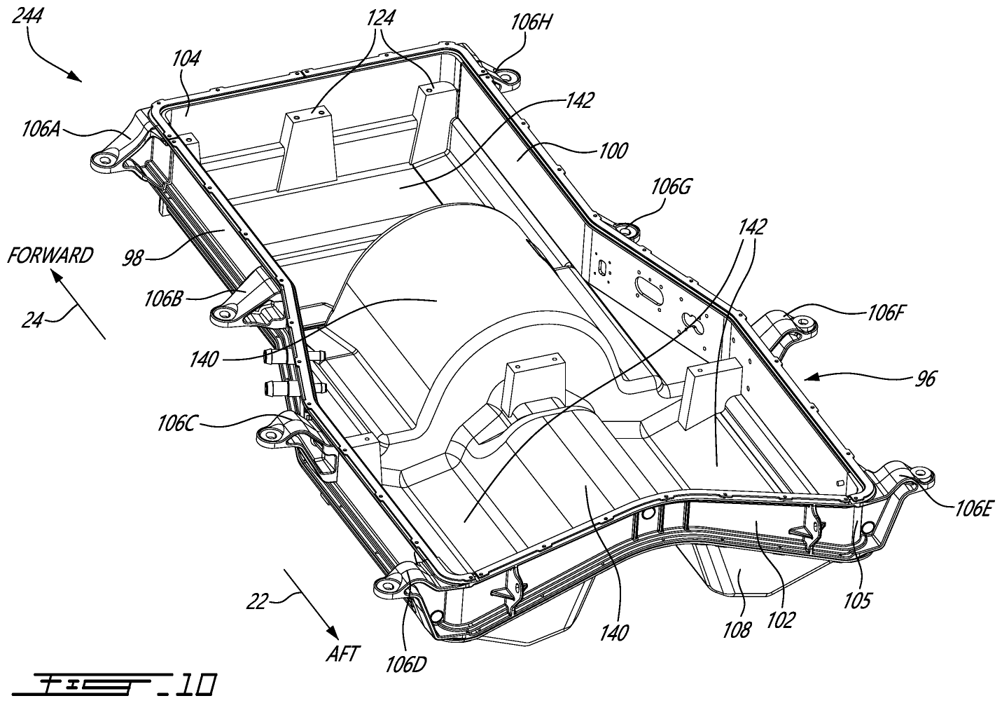

FIG. 9 is a partial schematic longitudinal cross-sectional view of enclosure 44 in a vertical plane including central axis 30. FIG. 9 shows aft battery module 46A and forward battery module 46F being housed in enclosure 44. Forward battery module 46F may be disposed forward of aft battery module 46A relative to central axis 30. First internal brace 136 and shelf 124 attached to aft brace 102 may support aft battery module 46A. First internal brace 136 may have an L-shaped cross-sectional profile. Second internal brace 138 and shelf 124 attached to forward brace 104 may support forward battery module 46F. Second internal brace 138 may have a square or rectangular cross-sectional profile. First internal brace 136 and/or second internal brace 138 may be disposed between aft battery module 46A and forward battery module 46F.

Other portions of frame 96 may also or instead support battery modules 46. In some embodiments, port member 98 and/or starboard member 100 may include shelves or other attachment points to support battery modules 46.

In some embodiments, battery modules 46 may be mounted between pairs of end plates 144 exerting a compressive force F on battery modules 46. In some embodiments, compressive force F applied to battery modules 46 may hinder delamination of battery cells during charging and/or discharging, thereby improving battery cell life. In some embodiments, compressive force F may be applied to battery modules 46 by way of one or more threaded rods 148 (only one being shown) extending through end plates 144 and applying a compressive preload on battery modules 46 via end plates 144. The use of end plates 144 and the connection of end plates 144 via threaded rods 148 may also contribute to the overall stiffness of frame 96.

In some embodiments, a volume between battery modules 46 and lower shell 108 and/or upper shell 110 may be partially or entirely filled with a flotation foam 150 suitable for use in marine vessels. For example, battery modules 46 and/or other components (e.g., battery management system) of watercraft 10 housed inside of enclosure 44 may be partially or entirely encased in flotation foam 150. In some embodiments, flotation foam 150 may enhance the rigidity of enclosure 44, enhance flotation, improve vibration dampening and/or provide thermal insulation. For example, flotation foam 150 may be installed inside of enclosure 44 as a pourable/expanding foam and/or as closed-cell foam mats or blocks.

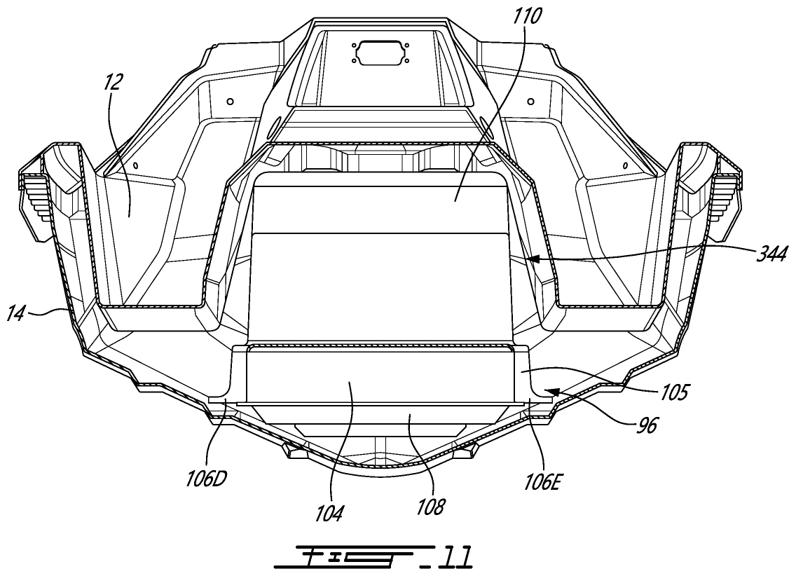

FIG. 10 is a perspective view of part of another exemplary battery enclosure 244. Enclosure 244 may include components of enclosure 44 described above. Like elements are referenced using like reference numerals. Enclosure 244 may include frame 96 disposed between lower shell 108 and upper shell 110 (not shown in FIG. 10. In contrast with enclosure 44, peripheral structure 105 of frame 96 and lower shell 108 may be integrally formed (e.g., molded together as one piece) to have a unitary construction. This embodiment could eliminate the need for a releasable sealed interface between peripheral structure 105 and lower shell 108.

In some embodiments, peripheral structure 105 and lower shell 108 may be made from a fiber-reinforced composite material. In embodiments where lower shell 108 may serve a structural function, first internal brace 136 and second internal brace 138 may be omitted from enclosure 244. In some embodiments, enclosure 244 may include first internal brace 136 and/or second internal brace 138 extending between and structurally interconnecting port member 98 with starboard member 100. In some embodiments, first internal brace 136 and/or second internal brace 138 may be manufactured separately from peripheral structure 105 and be subsequently assembled with the combined peripheral structure 105 and lower shell 108.

Enclosure 244 may include shelves 124 that may extend across an entire width of peripheral structure 105 and/or that have the form of discrete pillars that extend to the bottom of lower shell 108.

FIG. 11 is a cross-sectional view through hull 14 and deck 12 of watercraft 10 taken along line 11-11 in FIG. 1B showing another exemplary battery enclosure 344. Enclosure 344 may include components of enclosures 44 and 244 described above. Like elements are referenced using like reference numerals. In contrast with enclosures 44 and 244, enclosure 344 may house only battery modules 46 that are disposed forward of motor 50. Accordingly, peripheral structure 105 of frame 96 may be generally rectangular and the overall shape of enclosure 344 may be generally cuboid. Such configuration of enclosure 344 may reduce the complexity of frame 96 and also reduce the need for humps 140 and pockets 142 formed in lower shell 108.

As can be seen therefore, the examples described above and illustrated are intended to be exemplary only. The scope is defined by the appended claims.

What is claimed is:

1. An electric watercraft comprising:
a hull having a port side and a starboard side on opposite sides of a longitudinal central axis of the hull, the hull having an interior volume;
an electric motor for propelling the electric watercraft;
a battery operatively connected to drive the electric motor, the battery being disposed in the interior volume of the hull; and
a frame disposed in the interior volume of the hull and supporting the battery, the frame including a port member attached to the port side of the hull and a starboard member attached to the starboard side of the hull, the frame including a brace extending across the central axis of the hull and interconnecting the port member of the frame with the starboard member of the frame.

2. The electric watercraft as defined in claim 1, wherein the frame includes:
a first mount attached to the port side of the hull and defining a load path between the port side of the hull and the frame; and
a second mount attached to the starboard side of the hull and defining a load path between the starboard side of the hull and the frame.

3. The electric watercraft as defined in claim 1, wherein the frame includes:
two or more first mounts attached to the port side of the hull and defining two or more respective load paths between the port side of the hull and the frame, the two or more first mounts being longitudinally spaced apart relative to the central axis of the hull; and
two or more second mounts attached to the starboard side of the hull and defining two or more respective load paths between the starboard side of the hull and the frame, the two or more second mounts being longitudinally spaced apart relative to the central axis of the hull.

4. The electric watercraft as defined in claim 1, wherein:
the brace is a first brace;
the frame includes a second brace extending across the central axis of the hull and interconnecting the port member of the frame with the starboard member of the frame; and
the second brace is disposed forward of the first brace relative to the central axis of the hull.

5. The electric watercraft as defined in claim 4, wherein the port member, the starboard member, the first brace and the second brace define a peripheral structure surrounding the battery.

6. The electric watercraft as defined in claim 4, wherein the frame includes a third brace disposed between the first brace and the second brace along the central axis of the hull.

7. The electric watercraft as defined in claim 6, wherein the frame includes a fourth brace extending across the central axis of the hull and interconnecting the port member of the frame with the starboard member of the frame.

8. The electric watercraft as defined in claim 7, wherein the fourth brace is disposed between the third brace and the second brace.

9. The electric watercraft as defined in claim 6, comprising a drive shaft drivingly connecting the electric motor to an impeller of the electric watercraft, at least a portion of the third brace extending over the drive shaft of the electric watercraft.

10. The electric watercraft as defined in claim 6, wherein:
the battery includes an aft battery module and a forward battery module, the forward battery module being disposed forward of the aft battery module; and
the third brace is disposed between the aft battery module and the forward battery module.

11. The electric watercraft as defined in claim 10, wherein the aft battery module is supported by the first brace and the third brace.

12. The electric watercraft as defined in claim 11, wherein the frame exerts a compressive force on the aft battery module.

13. The electric watercraft as defined in claim 1, comprising an enclosure for housing the battery, the enclosure including the frame.

14. The electric watercraft as defined in claim 13, wherein:
the enclosure includes a lower shell and an upper shell disposed above the lower shell; and
the frame is disposed vertically between the lower shell and the upper shell.

15. The electric watercraft as defined in claim 14, wherein an upper side of the frame is in sealing engagement with the upper shell.

16. The electric watercraft as defined in claim 14, wherein a lower side of the frame is in sealing engagement with the lower shell.

17. The electric watercraft as defined in claim 14, wherein the frame and the lower shell have a unitary construction.

18. The electric watercraft as defined in claim 1, wherein:
the hull is made of a composite material; and
the brace is made of a metallic material.

19. The electric watercraft as defined in claim 1, wherein the brace is vertically above and spaced apart from an inner surface of the hull.

20. An electric watercraft comprising:
a seat for accommodating a rider of the electric watercraft;
a deck supporting the seat;
a hull connected to the deck to define an interior volume therebetween, the hull having a port side and a starboard side on opposite sides of a longitudinal central axis of the hull;
an electric motor for propelling the electric watercraft;
a battery operatively connected to drive the electric motor, the battery being disposed in the interior volume; and
a battery enclosure disposed in the interior volume and housing the battery, the battery enclosure including:
a frame supporting the battery and extending across the central axis of the hull;
a first tab extending outwardly from the frame and attached to the port side of the hull; and
a second tab extending outwardly from the frame and attached to the starboard side of the hull.

21. The electric watercraft as defined in claim 20, wherein the frame includes a peripheral structure surrounding the battery, the first tab and the second tab extending outwardly from the peripheral structure.

22. The electric watercraft as defined in claim 21, wherein the frame includes a brace interconnecting portions of the peripheral structure on opposite sides of the central axis of the hull.

23. The electric watercraft as defined in claim 22, wherein the brace forms a portion of the peripheral structure.

24. The electric watercraft as defined in claim 20, wherein the battery enclosure includes:
a lower shell; and
an upper shell disposed above the lower shell, the frame being disposed vertically between the lower shell and the upper shell.

25. A battery enclosure for a traction battery disposed inside a hull of an electric watercraft, the battery enclosure comprising:
a shell configured to house the traction battery; and
a frame to support the traction battery, the frame including:
a peripheral structure configured to extend around the traction battery; and
a plurality of mounting tabs extending outwardly from the peripheral structure and spaced apart around the peripheral structure, the mounting tabs being configured to attach the peripheral structure to a hull of the electric watercraft and define respective load paths between the hull and the peripheral structure.
